(19) United States
(12) Patent Application Publication
(10) Pub. No.: US 2006/0190663 A1
(43) Pub. Date: Aug. 24, 2006

(54) Chipset capable of supporting video cards of different specifications

(75) Inventor: Yu-Ji Lu, Ji-an Shiang (TW)

Correspondence Address: BRUCE H. TROXELL, SUITE 1404, 5205 LEESBURG PIKE, FALLS CHURCH, VA, 22041, US

(73) Assignee: ULi Electronic Inc.

(21) Appl. No.: 11/130,088

(22) Filed: May 17, 2005

(30) Foreign Application Priority Data
Feb. 18, 2005 (TW) 94104759

(51) Int. Cl. G06F 13/36

(52) U.S. Cl. 710/312

(57) ABSTRACT

The present invention provides a chipset comprising a north bridge with a PCI Express interface for coupling to a PCI Express video card and a south bridge with an AGP interface for coupling to an AGP video card, so as to enable the motherboard corresponding to the chipset to support both the AGP video card and the PCI Express video card simultaneously. In addition, the motherboard corresponding to the chipset of the invention can be programmed and controlled by software for achieving the functionalities such as Picture-in-Picture (PIP), video-in-a-window, and the like.

### FIELD OF THE INVENTION

The present invention relates to a chipset, and more particularly, to a chipset capable of supporting video cards with different specifications.

### BACKGROUND OF THE INVENTION

Peripheral Component Interconnect (PCI) uses a shared bus topology to allow communication among the different devices on the bus; the different PCI devices (i.e., a network card, a sound card, a RAID card, etc.) are all attached to the same bus, which is used to communicate with the CPU. Compared to the progress made every year in other computer-technology areas such as processors and video cards, computer I/O system technology would seem to be standing still. Hard drives, peripherals, LAN cards, sound cards, USB, and Firewire all pass data through the same I/O system as your first 486 PC with the PCI bus running at 33 mhz and shifting to 133 MB/s for data. With many high speed I/O devices today outside of the graphics card including Serial ATA (SATA)/ATA 150 (150 MB/s), Gigabyte Ethernet (125 MB/s), and 1394 B (100 MB/s), it is obvious that any one of these devices alone can completely saturate the PCI bus.

Over the past decade, video performance requirements have approximately doubled every two years. During this time, the graphics bus has transitioned from PCI to Accelerated Graphic Port (AGP), and from AGP to AGP2X, AGP4X, and finally today's AGP8X. AGP8X operates at 2.134 gigabytes per second (GB/sec). Despite this bandwidth, the progressive performance demands on the AGP bus are putting considerable loading on board design and interconnection costs. Like the PCI bus, extending the AGP bus grows difficulties and costs as frequencies increase.

The PCI Express architecture defines a high-performance, point-to-point, and scalable serial bus. A PCI Express link consists of dual simplex channels. Each channel is implemented as a transmit pair and a receive pair for simultaneous transmission in each direction. Moreover, because it is a point-to-point architecture, the entire bandwidth of each PCI Express bus is dedicated to the device at the end of the link. Multiple PCI Express devices can be active without interfering with each other. As the technology goes to market, each of these lanes should be capable of a 2.5 Gb/s data rate in each direction. The overall sustained transfer rate is about 250 MB/s.

PCI Express has the following advantages over PCI:
(1) Serial technology providing scalable performance.
(2) High bandwidth-Initially, 5-80 gigabits per second (Gbps) peak theoretical bandwidth, depending on the implementation.
(3) Point-to-point link dedicated to each device, rather than the PCI shared bus.
(4) Opportunities for lower latency (or delay) in server architectures, because PCI Express provides a more direct connection to the chip set Northbridge (see Note 2) than PCI-X.
(5) Small connectors and, in many cases, easier implementation for system designers.
(6) Advanced features—Quality of service (QoS) via isochronous channels for guaranteed bandwidth delivery when required, advanced power management, and native hot plug/hot swap support.
   By virtue of this, PCI Express will replace the PCI, PCI-X, and AGP parallel buses gradually over the next decade. It will initially replace the buses that need the additional implementation or features.

For instance, PCI Express will start to replace the AGP8X graphics bus, to provide high bandwidth and to support for multimedia traffic. However, during the replace-transition from AGP video card to PCI Express video card, there is no motherboard currently available as a go-between product that is capable of supporting the two video cards of different specifications simultaneously.

Please refer to FIG. 1A and FIG. 1B, which are respectively a schematic representation showing a prior-art chipset with PCI Express interface connecting to an PCI Express video card and a schematic representation showing a prior-art chipset with AGP interface connecting to an AGP video card. It is noted that the core logic chipset is split into two parts: the north bridge 110 and the south bridge 121, acts as a switch or router, and routes I/O traffic among the different devices that make up the system. This split is made for a couple of reasons, the most important of them is the fact that there are three types of devices that naturally work very closely together. Therefore, they need to have a fast access to each other: the CPU 101, the main memory, and the video card, which is the AGP video card 119 as in FIG. 1A or is the PCI Express video card 1I 15 as tin FIG. 1B. In the modern system, the video card's GPU is a second (or third) CPU by function, so it needs to share a privileged access to the main memory with the CPU(s). As a result, these three devices are all clustered together through the north bridge 110. The AGP video card 119 is connected thereto through the AGP bus 113 as in FIG. 1A and the PCI Express video card 115 is connected thereto through the PCI Express bus 117 as in FIG. 1B. In both FIG. 1A and FIG. 1B, the north bridge 110 is tied to a secondary bridge, the south bridge 121, which routes traffic from the different I/O devices 130 on the system: the hard drives, USB ports, Ethernet ports, etc. The traffic from these devices is routed through the south bridge 121 to the north bridge 110 and then on to the CPU 101. Moreover, the PCI bus 135 is attached to the south bridge 121 for connecting to PCI extension cards 140. Logically, a system layout of FIG. 1A can only adopt video card of AGP protocol and another layout of FIG. 1B can only adopt video card of PCI Express protocol. Therefore, while AGP video card and PCI Express video card coexist on the market, the motherboard constructed with respect to the system layout shown in FIG. 1A and FIG. 1B will have poor expansibility since it is limited to only one kind of video card specified by the north bridge 110.

In view of the above description, the present invention is intended to provide a chipset capable of supporting video cards of AGP and PCI Express specifications simultaneously so as to enable the motherboard corresponding to the chipset of the invention to have preferred expansibility.

### SUMMARY OF THE INVENTION

It is the primary object of the invention to provide a chipset for enabling a corresponding motherboard to support video cards of AGP and PCI Express specifications simultaneously. To achieve the above object, the present invention provides a chipset comprising a north bridge and a south bridge, for supporting video cards of various specifications so as to enable the motherboard corresponding to the chipset to support both an AGP video card and a PCI Express video card simultaneously.

Wherein, the south bridge, as an I/O bridge between a CPU and multiple peripherals, has an AGP interface for coupling to an AGP video card; the north bridge, coupled between the CPU and the south bridge, has a PCI Express interface for coupling to a PCI Express video card.

### BRIEF DESCRIPTION OF THE DRAWINGS

FIG. 1A and FIG. 1B are respectively a schematic representation showing a prior-art chipset with PCI Express interface connecting to an PCI Express video card and a schematic representation showing a prior-art chipset with AGP interface connecting to a AGP Express video card

FIG. 2 is a schematic representation showing a chipset capable of supporting video cards of various specifications by the interfaces of the north bridge thereof.

FIG. 3 is the top view showing the configuration of the chipset of FIG. 2 mounted on a corresponding motherboard.

FIG. 4 is a schematic representation showing a chipset capable of supporting video cards of various specifications according to a preferred embodiment of the invention.

FIG. 5 is the top view showing the configuration of the chipset of FIG. 4 mounted on a corresponding motherboard.

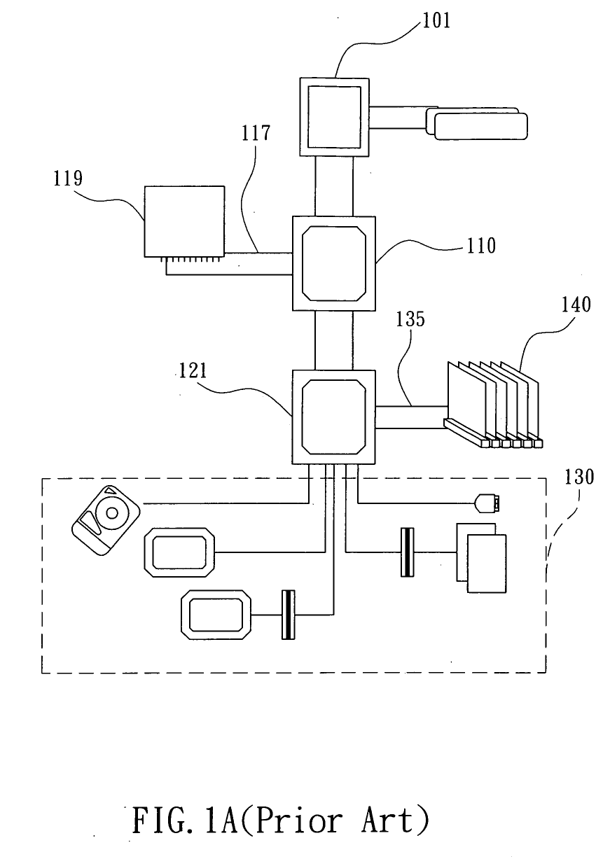

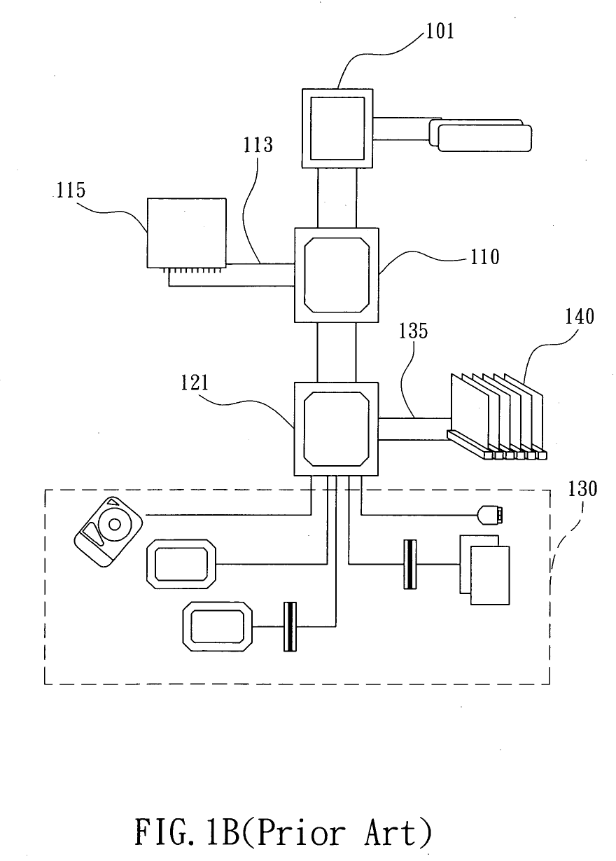

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

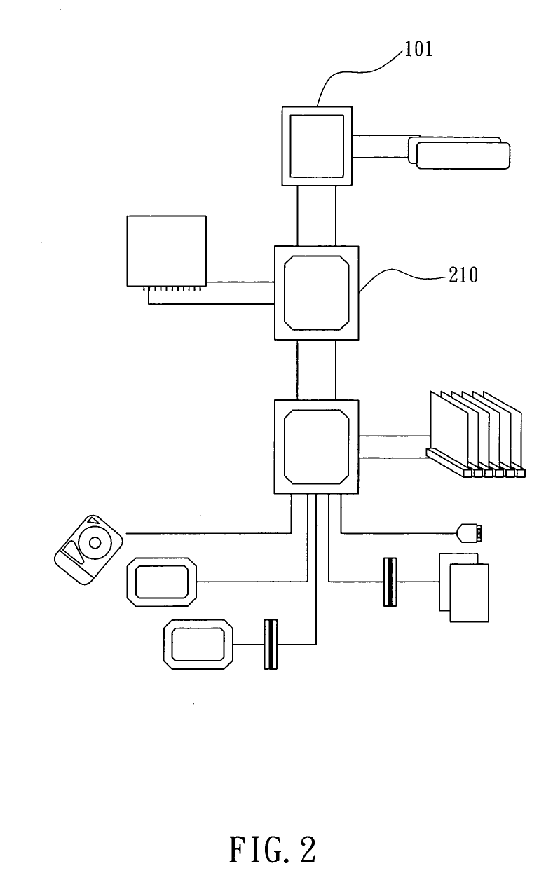

It was previously considered to configure both a PCI-Express interface and an AGP interface on the north bridge of a chipset of the invention, such that the object of the invention of providing a chipset for enabling a corresponding motherboard to support video cards of AGP and PCI Express specifications simultaneously can be achieved. The system layout of the above description is shown in FIG. 2, where the interfaces conforming to both the PCI Express and the AGP specifications are attached to the north bridge 210 for enabling the corresponding motherboard to support video cards of AGP and PCI Express specifications.

Nevertheless, while the north bridge of a chipset is configured with interfaces conforming to both the PCI Express and the AGP specifications, not only the die size of the north bridge will be increased, but also the problems of manufacturing cost and temperature control of the north bridge will appear.

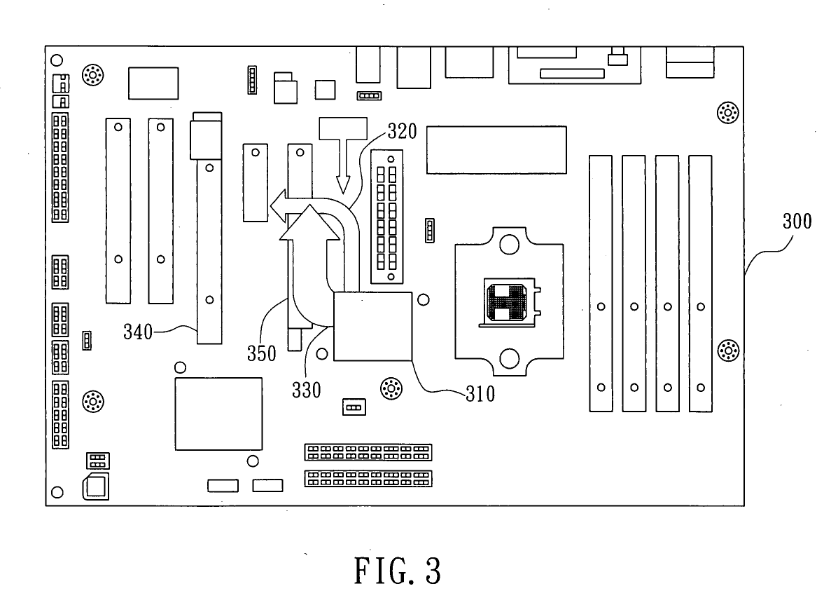

Please refer to FIG. 3, which is the top view showing the configuration of the chipset of FIG. 2 mounted on a corresponding motherboard. As shown in FIG. 3, the north bridge 310 of the chipset mounted on the corresponding motherboard 300 is configured with interfaces conforming to both the PCI Express and the AGP specifications, wherein the PCI Express interface is connected to a corresponding PCI Express slot 350 by a PCI Express bus 330 and the AGP interface is connected to a corresponding AGP slot 340 by an AGP bus 320 such that the motherboard 300 is enabled to support video cards of AGP and PCI Express specifications simultaneously.

However, in reality, the die size of the foregoing north bridge 310 is increased accordingly, and more particularly, in order to fulfill the layout of the AGP bus 320 and the PCI Express bus 330 respectively connecting the north bridge 310 to the AGP slot 340 and the PCI Express slot 350, it is infeasible that two layers out of the four-layer motherboard 300 are required for the implementation.

From the above description, it is noted that the consideration of configuring the north bridge with interfaces conforming to both the PCI Express and the AGP specifications for enabling a corresponding motherboard to support video cards of AGP and PCI Express specifications simultaneously is unrealistic.

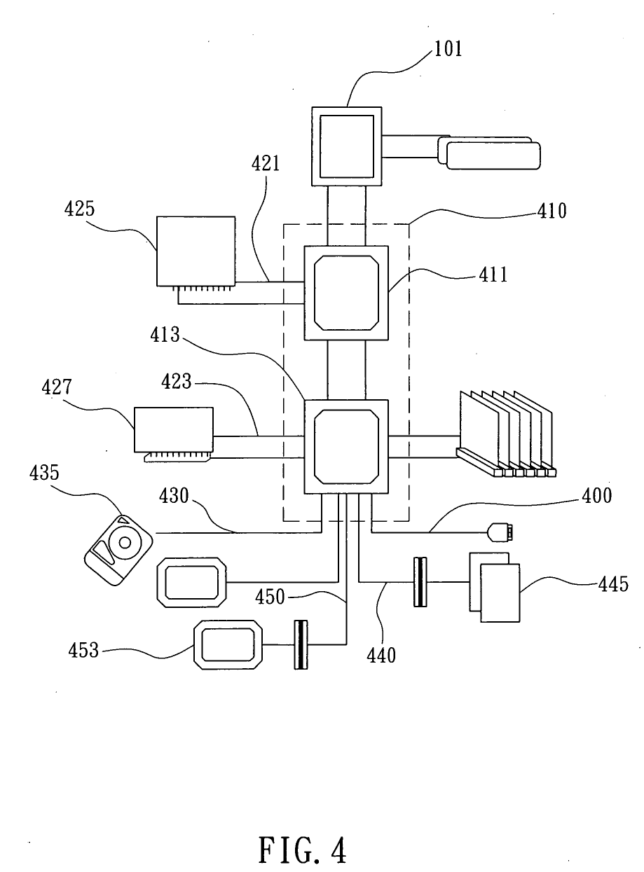

Therefore, the present invention provides a chipset comprising a north bridge with a PCI Express interface for coupling to a PCI Express video card and a south bridge with an AGP interface for coupling to an AGP video card, so as to enable the motherboard corresponding to the chipset to support both the AGP video card and the PCI Express video card simultaneously. As shown in FIG. 4, the chipset 410 corresponding to the center processor unit (CPU) 101 is consisted of a north bridge 411 and a south bridge 413, wherein each of the two bridges has an interface for coupling to a video card.

In the preferred embodiment of FIG. 4, a PCI Express interface is attached to the north bridge 411 which is connected to a PCI Express video card 425 by a PCI Express bus 421, and an AGP interface is attached to the south bridge 413 which is connected to an AGP video card 427 by an AGP bus 423. Moreover, the south bridge 413 further comprises an Integrated Drive Electronics (IDE) interface for coupling to an IDE device 435 by an IDE bus 430, a codec interface 440 for coupling to a codec chip 445, a low-pin-count (LPC) interface 450 for coupling to an LPC device 455, and an Universal Serial Bus (USB) interface 460 for coupling to an USB device.

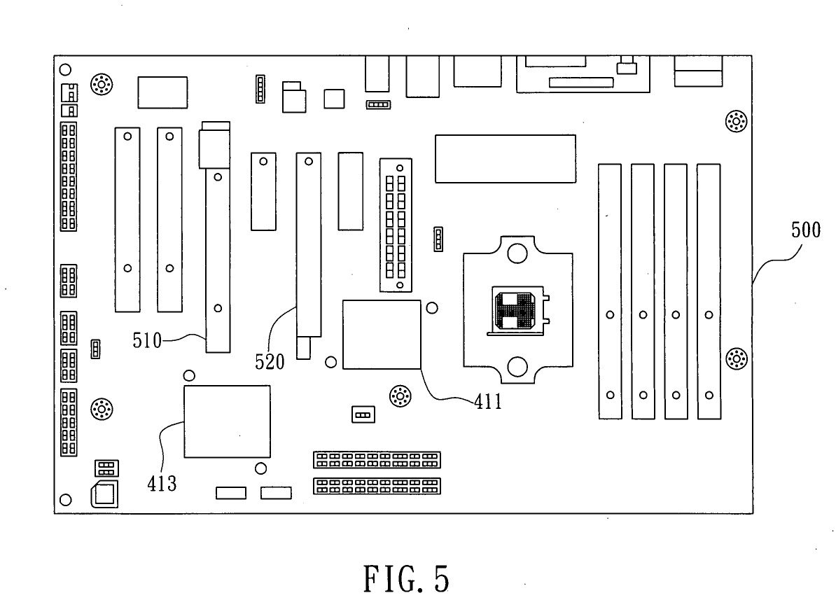

Please refer to FIG. 5, which is the top view showing the configuration of the chipset of FIG. 4 mounted on a corresponding motherboard. In FIG. 5, the north bridge 411 and the south bridge 413 mounted on the motherboard 500 respectively have a PCI Express interface and an AGP interface attached thereto while the PCI Express bus 421 is arranged with respect to the connection between the north bridge 411 and the PCI Express slot 520; the AGP bus 423 is arranged with respect to the connection between the south bridge 413 and the AGP slot 510, such that the layout of the motherboard 500 is relatively simplified and thus feasible.

To sum up, the present invention provides a chipset comprising a north bridge with a PCI Express interface for coupling to a PCI Express video card and a south bridge with an AGP interface for coupling to an AGP video card, so as to enable the motherboard corresponding to the chipset to support both the AGP video card and the PCI Express video card simultaneously. In addition, the motherboard corresponding to the chipset of the invention can be programmed and controlled by software for achieving the functionalities such as Picture-in-Picture (PIP), video-in-a-window, and the like.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A chipset capable of supporting video cards of different specifications, acting as a router and routing I/O traffic among a center processor unit (CPU) and a plurality of peripherals, the chipset comprising:
a south bridge, acting as an I/O bridge between the CPU and the plural peripherals, having an AGP interface for coupling to an AGP device; and
a north bridge, coupled between the CPU and the south bridge enabling the traffic from the south bridge to the CPU to be routed therethrough, having a PCI Express interface for coupling to a PCI Express device;
wherein the PCI Express interface and the AGP interface are respectively connected to the video cards while being used as interfaces of displaying.

2. The chipset of claim 1, wherein the south bridge further comprises a PCI interface for coupling to a PCI device.

3. The chipset of claim 1, wherein the PCI Express interface is coupled to the PCI Express device through a PCI Express bus.

4. The chipset of claim 1, wherein the AGP interface is coupled to the AGP device through an AGP bus.

5. The chipset of claim 1, wherein the south bridge further comprises an Integrated Drive Electronics (IDE) interface for coupling to an IDE device.

6. The chipset of claim 1, wherein the IDE interface is coupled to the IDE device through an IDE bus.

7. The chipset of claim 1, wherein the south bridge further comprises a codec interface for coupling to a codec chip.

8. The chipset of claim 1, wherein the south bridge further comprises a low-pin-count (LPC) interface for coupling to an LPC device.

9. The chipset of claim 1, wherein the south bridge further comprises an Universal Serial Bus (USB) interface for coupling to an USB device.
